(19) United States
(12) Patent Application Publication
(10) Pub. No.: US 2022/0183129 A1
(43) Pub. Date: Jun. 9, 2022

(54) LIGHTING DEVICE, SYSTEM COMPRISING LIGHTING DEVICES AND METHOD OF OPERATING THE SYSTEM

(71) Applicant: LEDVANCE GmbH, Garching bei Munchen (DE)

(72) Inventors: Krister Bergenek, Regensburg (DE); Alexander Niggebaum, Munchen (DE)

(21) Appl. No.: 17/541,570

(22) Filed: Dec. 3, 2021

(30) Foreign Application Priority Data
Dec. 9, 2020 (DE) 102020132833.8

(51) Int. Cl. H05B 47/115; H05B 47/11; H05B 47/19; H05B 45/20; G01S 13/88

(52) U.S. Cl. CPC H05B 47/115; H05B 47/11; G01S 13/88; H05B 45/20; H05B 47/19

(57) ABSTRACT

A lighting device for forming systems of lighting devices and a method for operating the system of lighting devices are disclosed. The lighting device comprises a lighting source for generating light, control electronics for controlling the lighting source, as well as at least one radar sensor for detecting presence information. The radar sensor is equipped with at least one HF emitter and at least one HF receiver, wherein the HF emitter and the HF receiver are designed in such a way that they can be used as a communication channel for transmitting data with other lighting devices. The control electronics are designed to control the lighting source based on the presence information and/or on the transmitted data.

### CROSS-REFERENCE TO RELATED APPLICATIONS AND PRIORITY

This patent application claims priority from German Patent Application No. 102020132833.8, filed Dec. 9, 2020, which is herein incorporated by reference in its entirety.

### TECHNICAL FIELD

The present disclosure relates, in general, to lighting devices and, more specifically, to lighting devices for forming systems of lighting devices and methods of operating the system of lighting devices.

### BACKGROUND

Lighting devices equipped with motion sensors are known that can switch on or off depending on the presence or absence of people. If a person enters a room equipped with such lighting devices (for example, a staircase), the lighting devices switch on after presence detection. The light is switched on locally when presence is detected, so that the person approaches a dark area until another lighting device detects presence. There are also lighting devices known that illuminate a room (for example, a staircase) with a single switch. In this case, the light is also switched on in those areas of the room where it is not needed or not needed to the same extent as in the immediate vicinity of the person, so that electrical energy is consumed unnecessarily.

### SUMMARY

It is an object of the present disclosure to provide a lighting device which makes it possible to form energy-saving systems of lighting devices.

To solve this task, a lighting device is proposed according to a first aspect. The lighting device comprises a light source for generating light, control electronics for controlling the light source and at least one radar sensor for detecting presence information. The radar sensor is designed with an HF emitter/HF receiver as a communication channel for transmitting data with other lighting devices. The control electronics are designed to control the light source based on the presence information and/or the transmitted data.

The lighting device can be designed, in particular, as an LED lighting device with an LED light source and an LED driver. The LED driver can be designed as part of the control electronics or as a separate module. In particular, the control electronics may be at least partially formed in the separate module (control module). The control electronics for driving the light source may comprise a processor, a memory, and switching electronics for driving the light source, such as switching on/off, dimming, flashing, etc. The control electronics can be configured in such a way that the control of the light source is based on the presence information detected by the radar sensor and/or on the data transmitted by other lighting devices. By taking into account the presence information and/or the data transmitted by the other lighting devices, the lighting device can be controlled in a situation-dependent manner and in a coordinated manner with other lighting devices. With the use of the HF emitter/HF receiver as a communication channel between the lighting devices, no cabling is required for communication between the luminaires, and no further lighting management components, such as a gateway or application controller, are required. The communication channel has a range or communication radius. The range of the radar sensor can be easily pre-set at the factory so that the transmitted data typically only reaches the adjacent rooms or areas.

The radar sensor can be designed to detect direction and/or speed information of one or more persons, and the control electronics can be configured to control the illuminant based on the direction and/or speed information. With the detection of the direction and/or speed of the persons, it is possible to decide which lighting device the persons are moving towards, so that one or more lighting sources can be controlled in advance, in particular, before the persons reach the lighting space of the lighting device. The radar sensor can be designed as part of the sensor system or as part of the control module or as an independent component and can be integrated in the luminaire so that it is invisible from the outside.

The lighting device may comprise a sensor system for detecting at least one sensor signal. The sensor system can be, in particular, at least partially accommodated in a sensor module.

The sensor system can be designed to record, convert, and/or process environmental information. The sensor system further may be adapted to transmit data to other functional units or modules of the lighting device and/or to other lighting devices. In some embodiments, the sensor system may comprise a daylight sensor, a humidity sensor, a microphone, an ultrasonic sensor, a UV light sensor, and/or other sensors. Sensors may be designed to pick up environmental information and convert it into data. The data or signals, in particular, control signals or sensor signals, can be generated by the sensors or by the control electronics and forwarded to other modules of the lighting device or to other modules of other lighting devices. The own sensor system from the point of view of the control electronics is the sensor system that is installed in the same lighting device as the control electronics itself.

The environmental information can include presence information and optionally further information from the environment of the lighting device, such as temperature, air pressure, etc., depending on the characteristics of the sensor system. In principle, any type of environment in which the lighting devices can be located can be considered as an environment. The presence information may include, in particular, information about presence, movement, direction of movement, speed of movement, number of persons, or other information about persons in an environment.

In a system of lighting devices, the lighting device can take on the role of a subordinate lighting device without a sensor system (slave), which cannot receive environmental information itself but is dependent in its control behaviour on environmental information from a higher-level lighting device with a sensor system (master). The lighting device can be dynamically controlled depending on the situation with the help of environmental information.

The sensor system can include an air pressure sensor for detecting the current air pressure. The air pressure sensor can be designed to react to air pressure changes that are caused, in particular, by the presence of people or the entering or leaving of the environment, (e.g., a part of a building or staircase). These air pressure changes may include characteristic pressure fluctuations and signals caused by the opening or closing of a door. With the evaluation of the pressure sensor signal by the control electronics, conclusions can be drawn about the opening or closing processes of a door. In combination with the evaluation of the radar signal, according to which no or one person is present, it also can be determined from this whether a person is entering or leaving the room or the staircase. This data can be transmitted to other lighting devices so that the control electronics of the other lighting devices can control the lighting sources of the other lighting devices accordingly.

The sensor system can include a daylight sensor. The control module and the LED driver can be designed in such a way that the light source can be dimmed based on the detected daylight level. The extension of the sensor system to include a daylight sensor and the dimmability of the lighting device allow the lighting source to be operated with a weakened power. Due to the dimming of the lighting device taking into account the daylight level, an unnecessarily strong illumination of the lighting devices can be avoided, so that the consumption of electrical energy can be reduced.

The lighting device, in particular, the sensor system or sensor module, may comprise a communication module with at least one wireless communication method such as ZigBee, DALI, Bluetooth, Wi-Fi, or other methods. ZigBee® is a registered trademark of the ZigBee Alliance. Bluetooth® is a registered trademark of the Bluetooth Special Interest Group. DALI® (Digital Addressable Lighting Interface) is a registered trademark of the International Standards Consortium for Lighting and Building Automation Networks. Wi-Fi® is a registered trademark of the Wi-Fi Alliance. The communication module allows the exchange of additional information between lighting devices in a simple way based on a standard protocol.

The control electronics and the lighting source can be designed in such a way that the color temperature and/or the color of the light source can be changed. The extension of the control module and the light source to change the color temperature and/or color allows the adjustment of the color temperatures/colors, according to occasion-related, mood-dependent, or personal preferences.

The lighting device can be constructed in a modular way. In particular, the individual functional units, such as control electronics, light sources, and sensor systems, can be designed as separate or interchangeable modules. The modular design of the lighting device allows a flexible assembly of the lighting device. For example, low-cost lighting devices can be provided for smaller rooms, corridors, or staircases without sensor systems or further components. If required, these components can be retrofitted in a modular fashion so that the functionality of the lighting device can be expanded. The lighting device, thus, basically can be used for all rooms or outdoor areas, such as long corridors, hallways, underground garages, storage areas, etc.

According to a second aspect, a system of lighting devices is proposed. The system of lighting devices comprises at least one first lighting device and at least one second lighting device, each comprising at least one radar sensor for detecting presence information. The respective radar sensor is equipped with at least one HF emitter and at least one HF receiver, wherein the HF emitter and the HF receiver are designed such that they can be used as a communication channel for transmitting data with other lighting devices. The respective control electronics are adapted to control the lighting source based on the presence information and/or on the transmitted data. The system may comprise a plurality of lighting devices and may be part of a Light Management System (LMS). In particular, an LMS may comprise several luminaires connected to form a network. By taking into account the presence information or the data transmitted between the lighting devices, the lighting device can be controlled in a situation-dependent manner and in a coordinated manner with other lighting devices. By using the HF emitter or HF receiver as a communication channel between the lighting devices, the provision of a separate communication module can be saved.

The first lighting device can comprise a sensor system for detecting environmental information, a radar sensor as a communication channel for transmitting the environmental information, wherein the control electronics can be configured to control the second lighting device at least partially based on the transmitted environmental information. The lighting device can be dynamically controlled by means of sensor signals depending on the situation.

The first and the second lighting device can each comprise a communication module which is designed in such a way that the communication between the first lighting device and the second lighting device can take place at least partially via the communication module. In particular, the communication between the luminaires can be wireless. By communicating between the lighting devices via the communication module, communication can be maintained even if radar communication between the lighting devices is impaired.

According to a third aspect, a method for operating a system of lighting devices is proposed, wherein the system comprises a first and a second lighting device. The lighting devices each comprise a lighting source, a control electronics for controlling the lighting source, and at least one radar sensor for detecting presence information. The respective radar sensor is designed with an HF emitter/HF receiver as a communication channel for transmitting data between the first lighting device and the second lighting device. The respective control electronics is designed to control the respective lighting source based on presence information and/or on the transmitted data, such as control signals. The method comprises a detection of the radar sensor of the first lighting device and/or the second lighting device, transmitting data between the first lighting device and the second lighting device, and driving the first and/or the second lighting device by the control electronics of the first and/or second lighting device at least partially based on the transmitted data.

By taking into account the environmental information or the presence information or the data transmitted between the lighting devices, the lighting device can be controlled depending on the situation and in a coordinated manner with other lighting devices.

The first lighting device may comprise a sensor system and the method may further comprise determining environmental information by means of the sensor system of the first lighting device. The method may further comprise generating data based on the environmental information, transmitting the data to the control electronics of the second lighting device, and controlling the second lighting device by the control electronics of the second lighting device. Due to the environmental information or the presence information or the data transmitted between the lighting devices from the first lighting device (master) to the second lighting device (slave), the second lighting device does not need its own sensor system, whereby the overall costs of the system can be reduced.

The first lighting device and the second lighting device can each be equipped with a sensor system, in particular, with a sensor module. The method can further comprise determining environmental information via the respective sensor systems of the first and second lighting device, generating data based on the environmental information, and controlling the lighting device by the control electronics based at least partially on the transmitted control signals. In particular, several master lighting devices, possibly with their respective slave lighting devices, can communicate with each other in an LMS, so that even larger premises or outdoor areas can be equipped with master-slave systems.

The first and second light devices may each be equipped with at least one air pressure sensor. The method may comprise determining the air pressure value via the respective air pressure sensor of the respective sensor system of the light devices and transmitting the respective air pressure value to each other. The method may further comprise comparing the two air pressure values and identifying, in particular, by the control electronics, the relative position of the lighting devices to each other based on the comparison of own determined air pressure and transmitted air pressure. In an LMS, the air pressure values can, in particular, be transmitted between the lighting devices located within a communication radius. For example, if the first lighting device is spatially higher than the second lighting device, the air pressure of the first lighting device is lower than the transmitted air pressure and vice versa. Based on the air pressure comparison, conclusions can be drawn about the relative position of lighting devices, which can be taken into account by the respective control electronics when controlling the respective lighting device. In particular, the lighting fixtures in stairwells, halls, etc., can configure themselves automatically, so that the methods are possible without significant, time-consuming, and expensive manual configuration.

### BRIEF DESCRIPTION OF THE DRAWINGS

The present disclosure is now explained in more detail with the aid of the attached figures. The same reference signs are used in the figures for identical or similarly acting parts.

FIG. 1 schematically shows a lighting device according to an embodiment example,

FIG. 2 shows a lighting device in modular construction according to an example,

FIG. 3 shows a lighting device according to a further example,

FIG. 4 shows a lighting device according to another embodiment,

FIG. 5 shows a first and a second lighting device according to an embodiment example,

FIG. 6 shows a flow diagram of a method according to an example,

FIG. 7 schematically shows a system of lighting devices in an environment according to an embodiment example,

FIG. 8 schematically shows a system of lighting devices in an environment according to an embodiment, and

FIG. 9 shows an example of the method for controlling the lighting devices.

### DETAILED DESCRIPTION OF THE DRAWINGS

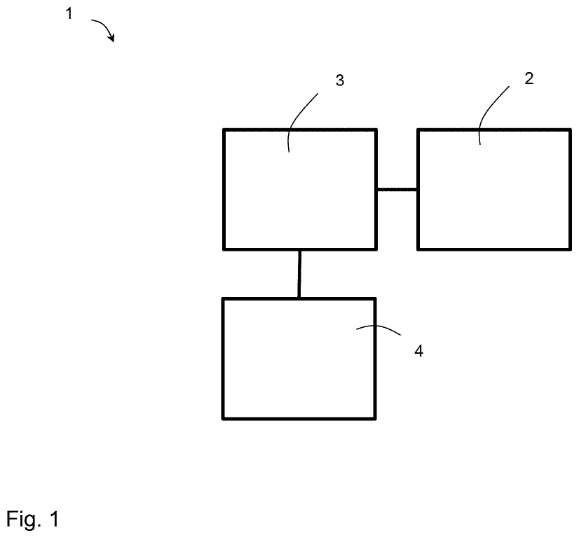

FIG. 1 schematically shows a lighting device according to an example. The lighting device 1 comprises a light source 2, control electronics 3 for controlling the light source 2, and a radar sensor 4 for detecting presence information, wherein the radar sensor 4 is designed with an HF emitter/HF receiver as a communication channel for communication with other lighting devices. The lighting device 1 may, in particular, be formed as an LED lighting device with an LED lighting source and an LED driver. The LED driver can be designed as part of the control electronics or as a separate module.

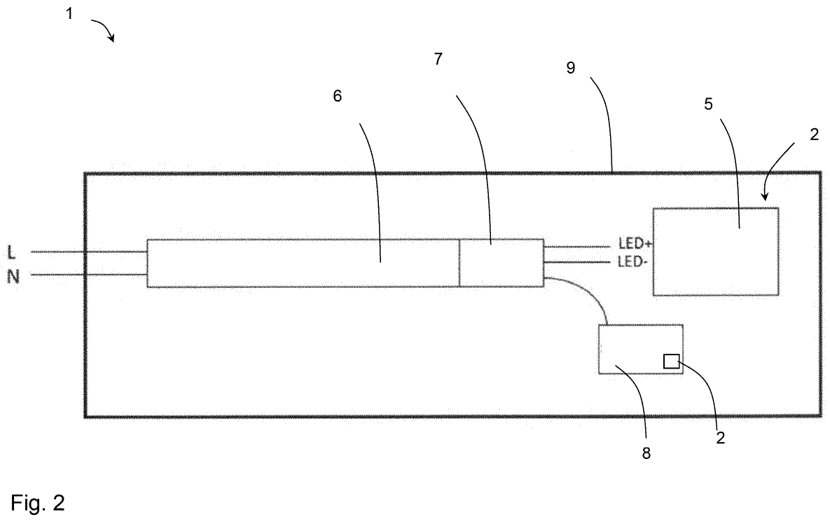

FIG. 2 shows a lighting device in modular design according to an embodiment example. The lighting device 1 comprises an LED light engine 5 with the light source 2, which is designed as an LED light source. The lighting device 1 comprises an LED driver 6 for driving the LED light engine 5, a control module 7, and a sensor module 8 with a radar sensor 4. In the embodiment example shown, the radar sensor 4 is formed as part of the sensor module 8.

In this embodiment example, the lighting device 1 is designed as a luminaire and has a luminaire body 9. The LED driver 6, the control module 7, the sensor module 8, and the LED light engine 5 are located within the luminaire body 9 of the lighting device 1. The LED driver 6 has a primary side with contacts L and N for connection to the mains and a secondary side with contacts LED+ and LED− for connection to the LED light engine 5.

The control module 8 may preferably be connected to the secondary side of the LED driver 6. In some embodiments, the control module 8 may be an integral part of the LED driver 6. The control module 8 can receive data and control the LED driver 6 of the lighting device or luminaire and, thus, the brightness and possibly the color temperature of the luminaire. The LED driver 6 can preferably be dimmable and offer interfaces for the power supply and the control of a control module.

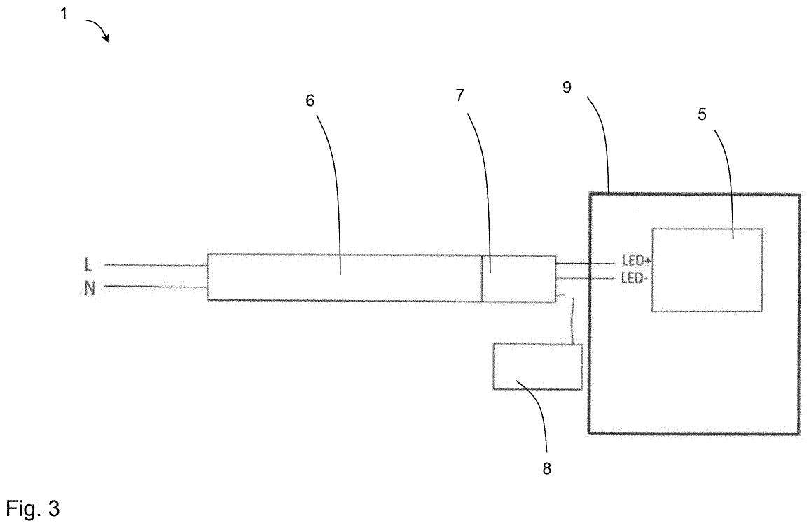

FIG. 3 shows a lighting device according to a further example. The lighting device 1 of FIG. 3 corresponds essentially to the embodiment example of FIG. 2, wherein the LED driver 6, the control module 7, and the sensor module 8 with the radar sensor 4 (not shown) are located outside the luminaire body 9. The LED light engine 5 is located inside the luminaire body 9.

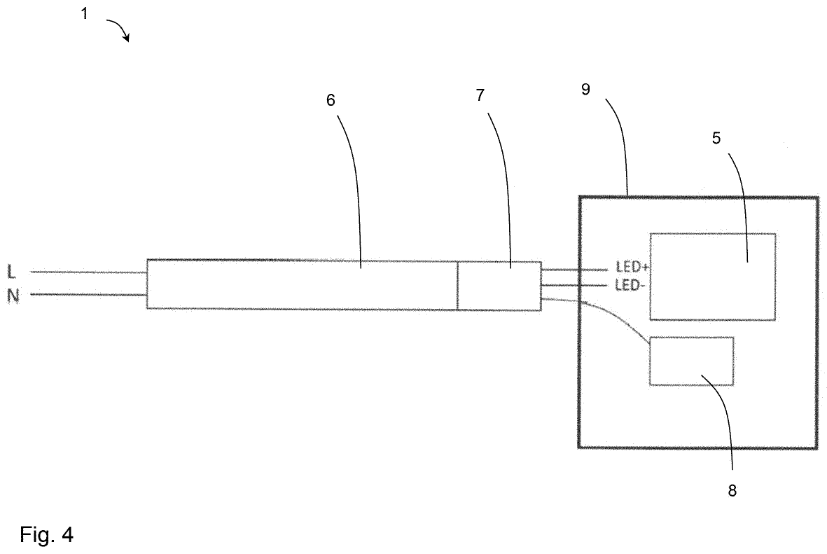

FIG. 4 shows a lighting device according to another embodiment. The lighting device 1 of FIG. 4 corresponds essentially to the embodiment example of FIG. 3, wherein the LED driver 6 and the control module 7 are formed outside the luminaire body 9. The LED light engine 5 and the sensor module 8 are located inside the luminaire body 9.

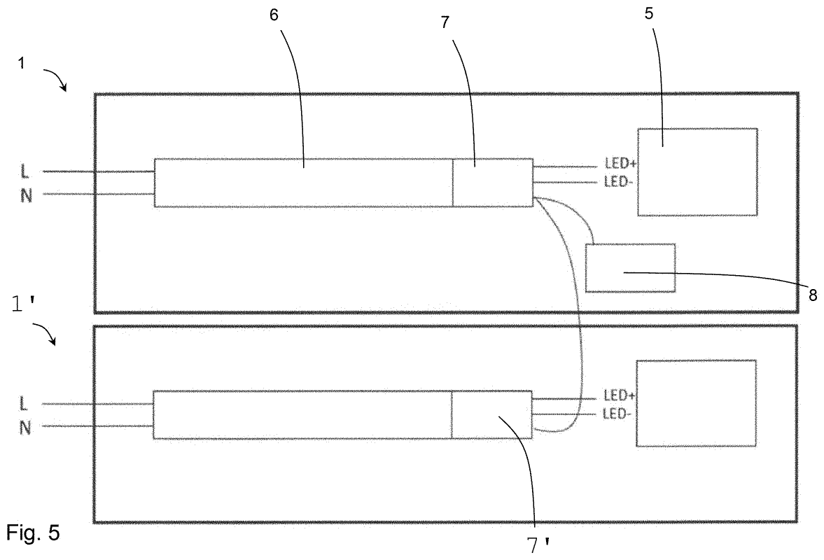

FIG. 5 shows a first and a second lighting device according to an embodiment example. The first lighting device 1 and the second lighting device 1′ essentially correspond to the embodiment example in FIG. 2, wherein the second lighting device 1′ does not have a sensor module. The information or data detected by the sensor module 8 of the first lighting device 1 is forwarded by the control module 7 of the first lighting device 1 to the control module 7′ of the second lighting device 1′. In some embodiments, the detected information is forwarded by the sensor module 7 of the first lighting device 1 to the control module 7′ of the second lighting device 1′.

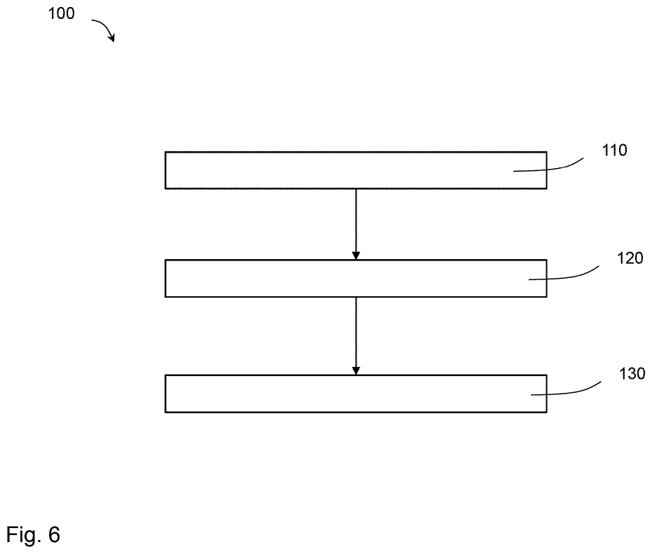

FIG. 6 shows a flow diagram of a method according to an embodiment. The method 100 shown can be performed with a first and a second lighting device according to the first aspect.

In a step 110, presence information is detected with the radar sensor of the first lighting device and/or the second lighting device. For example, a person can be detected by the radar sensor of a lighting device. Data corresponding to the detection of the person can be stored in a memory of the control electronics. In a further step 120, the data representing the presence information are transmitted from the first lighting device to the second lighting device. In a subsequent step 130, the second lighting device is controlled at least partially based on the transmitted data.

The method can include an identification of the relative position or relative height of the lighting devices to each other. The information about the relative position or relative height of the lighting devices together with the presence information of the person makes it possible to control only the lighting device lying in the direction of movement of the person.

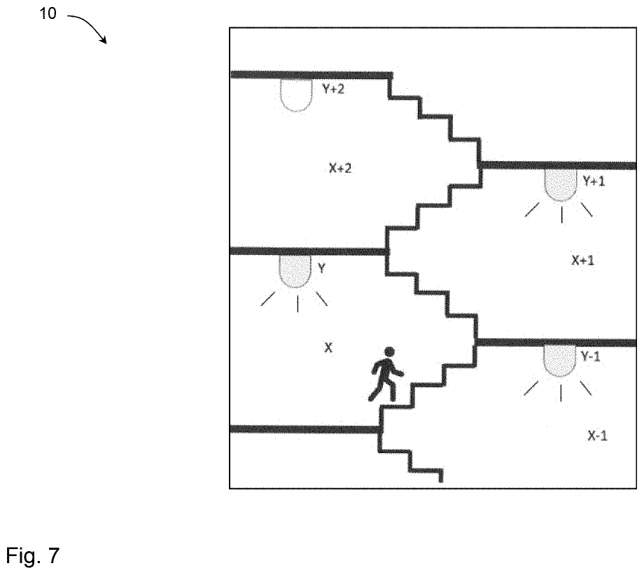

FIG. 7 schematically shows a system of lighting devices in an environment according to an embodiment example. In this example, a staircase is chosen as the environment 1000. The staircase comprises several areas and is divided into floors X−1 to X+2. On each floor, in this embodiment example, there is a lighting device Y−1 to Y+2. In this embodiment example, the lighting devices Y−1 to Y+2 each have a radar sensor with a range or a communication radius. The range of the radar sensor may be pre-set at the factory so that the transmitted data typically only reaches the adjacent floors.

The lighting device Y detects the presence of a person. The corresponding data are transmitted to other luminaires—in this case Y+1 and Y−1—within the range of the signal from the radar sensor of the lighting device Y. The luminaires Y+1 and Y−1 are controlled accordingly by their respective control electronics. The lines emanating radially from the lighting devices are intended to indicate the lighting of the lighting devices.

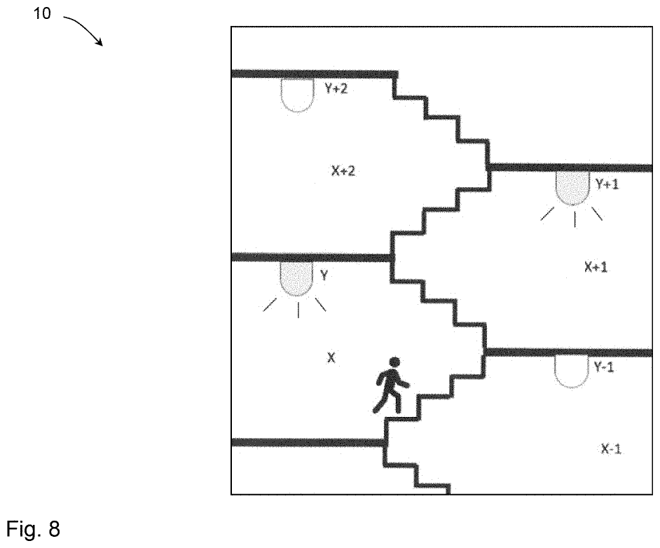

FIG. 8 schematically shows the system of lighting devices in an environment according to another embodiment, wherein the identification of the relative position of the lighting devices to each other has already been carried out as explained in the description of FIG. 6.

FIG. 8 shows the floors X−1 to X+2 of a staircase, the individual floors are illuminated with the lighting devices Y−1 to Y+2. As soon as the radar sensor on floor X detects the person with lighting device Y, the radar sensor of lighting device Y can transmit data with information about the direction of movement of the person and the relative height of the lighting device to all neighbouring lighting devices. By comparing its own relative height with the relative height contained in the data, the lighting device Y+1 recognises that it must be switched on, and the lighting device Y−1 recognises that it does not need to be switched on or can remain in a dimmed state.

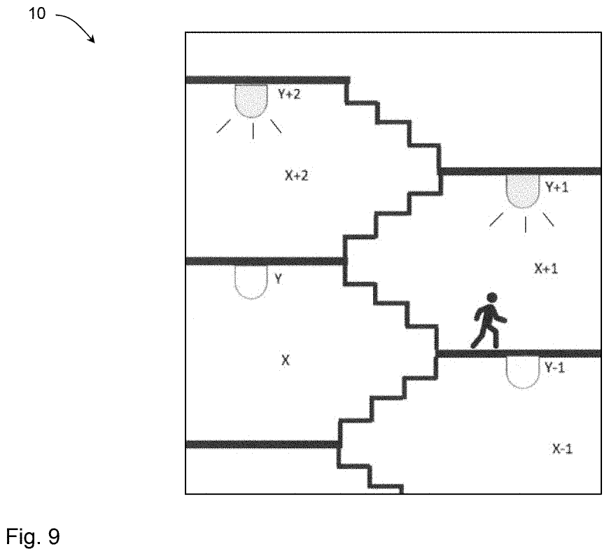

FIG. 9 schematically shows the system of lighting devices according to FIG. 8 in another switching state. As soon as the radar sensor on floor X+1 detects the person with lighting device Y+1, the radar sensor of lighting device Y+1 sends a signal with information about the direction of movement of the person and the relative height of the lighting device to all neighbouring lighting devices. By comparing its own relative height with the relative height contained in the signal, the lighting device Y+2 recognises that it must be switched on, and the lighting device Y recognises that it must be switched off or switched to a dimmed state. A targeted activation of the lighting devices is, thus, possible, whereby a setting of fixed follow-up times for lighting devices can be avoided. Thus, the number of illuminated lights in the vicinity of the person can be reduced by one third from 3 to 2, so that the power consumption can also be reduced by one third.

The embodiment examples described above allow a targeted activation of the luminaires only in the direction in which the person is moving (i.e., only on floor X−1 or X+1 FIGS. 8, 9).

The radar sensor can not only detect presence but also determine the direction and speed of the person. It is, thus, possible to decide whether the person is moving up or down the stairs. This information is at first worthless, as the luminaires should explicitly not be configured by the installer in a time-consuming way in order to store the number of floors or similar information. Through the integration of an air pressure sensor in the luminaire, however, it is possible to distinguish the relative installation height (i.e., relative number of floors) of the luminaires. With this information, each luminaire can decide whether to switch on the light at full brightness or not.

In a further embodiment, the data transmitted by the lighting device Y can be supplemented with a range number N of the luminaires to be activated in the direction of movement. The lighting device Y+1 can forward the data with the range number N−1 to the lighting device Y+2, etc., until the data reaches the lighting device Y+N. The lighting device Y+N is switched on but no longer sends the data on.

It should be noted that this communication via the previously mentioned communication can take place not only via the radar antennas but also via established systems such as ZigBee or DALI.

Although at least one exemplary embodiment has been shown in the foregoing description, various changes and modifications may be made. The aforementioned embodiments are examples only and are not intended to limit the scope, applicability, or configuration of the present disclosure in any way. Rather, the foregoing description provides the person skilled in the art with a plan for implementing at least one exemplary embodiment, wherein numerous changes in the function and arrangement of elements described in an exemplary embodiment may be made without departing from the scope of protection of the appended claims and their legal equivalents. Furthermore, according to the principles described herein, several modules or several products also can be connected with each other in order to obtain further functions.

### LIST OF REFERENCE SIGNS

1 lighting device
2 lighting source
3 control electronics
4 radar sensor
5 LED Light Engine
6 LED driver
7 control module
8 sensor module
9 luminaire body
100 method
110 method step
120 method step
130 method step
1000 environment
N power supply connection
L power supply connection
LED+ contact
LED− contact
X−1 floor
X floor
X+1 floor
X+2 floor
Y−1 floor X−1 lighting device
Y floor X lighting device
Y+1 floor X+1 lighting device
Y+2 floor X+2 lighting device

What is claimed is:

1. A lighting device comprising:
a lighting source configured to generate light;
a radar sensor configured to detect presence information, the radar sensor comprising at least one HF emitter and at least one HF receiver configured for use as a communication channel for transmitting data with one or more other lighting devices; and
control electronics configured to control the lighting source based on at least one of the presence information and the data transmitted.

2. The lighting device according to claim 1, wherein:
the radar sensor is further configured to detect at least one of direction information and speed information pertaining to at least one person; and
the control electronics are further configured to control the lighting source based on at least one of the direction information and the speed information.

3. The lighting device according to claim 1, further comprising a sensor system configured to detect at least one sensor signal.

4. The lighting device according to claim 3, wherein the sensor system comprises an air pressure sensor configured to detect a current air pressure.

5. The lighting device according to claim 3, wherein:
the sensor system comprises a daylight sensor; and
the control electronics are further configured for use in dimming the lighting source based on detected daylight.

6. The lighting device according to claim 1, further comprising a communication module configured for wireless communication via at least one of a ZigBee protocol, a DALI protocol, a Bluetooth protocol, and a Wi-Fi protocol.

7. The lighting device according to claim 1, wherein the control electronics are further configured for use in changing at least one of a color temperature and a color of the lighting source.

8. The lighting device according to claim 1, wherein the lighting device is further configured to be assembled in a modular manner.

9. A system comprising a first lighting device and a second lighting device, each configured according to claim 1, wherein:
the first lighting device further comprises a sensor system configured to detect environmental information; and
the control electronics of the first lighting device are further configured to control the second lighting device based at least in part on the environmental information.

10. The system according to claim 9, wherein each of the first lighting device and the second lighting device further comprises a communication module configured such that communication between the first lighting device and the second lighting device occurs at least in part via the communication module.

11. A method of operating a system comprising a first lighting device and a second lighting device, wherein the first lighting device and the second lighting device each comprise (a) a lighting source configured to generate light, (b) a radar sensor configured to detect presence information, the radar sensor comprising at least one HF emitter and at least one HF receiver configured for use as a communication channel for transmitting data with one or more other lighting devices, and (c) control electronics configured to control the lighting source based on at least one of the presence information and the data transmitted, the method comprising:
detecting the presence information with the radar sensor of at least one of the first lighting device and the second lighting device;
transmitting data between the first lighting device and the second lighting device; and
controlling at least one of the first lighting device and the second lighting device via the control electronics of at least one of the first lighting device and the second lighting device based at least in part on the transmitted data.

12. The method according to claim 11, wherein the first lighting device further comprises (d) a sensor system, and wherein the method further comprises:
determining environmental information via the sensor system;
generating data based on the environmental information;
transmitting a control signal to the control electronics of the second lighting device; and
controlling the second lighting device via the control electronics of the second lighting device.

13. The method according to claim 11, wherein each of the first lighting device and the second lighting device further comprises (d) a sensor system, and wherein the method further comprises:
determining environmental information via the respective sensor system of the first lighting device and the second lighting device;
generating data based on the environmental information;
transmitting a control signal to the other of the first lighting device and the second lighting device; and
controlling at least one of the first lighting device and the second lighting device via the respective control electronics based at least in part on the transmitted control signal.

14. The method according to claim 11, wherein each of the first lighting device and the second lighting device further comprises (d) an air pressure sensor, and wherein the method further comprises:
determining an air pressure value via the respective air pressure sensors of the first lighting device and the second lighting device;
mutually transmitting the respective air pressure values;
comparing the respective air pressure values; and
identifying relative positioning of the first lighting device and the second lighting device with respect to each other by comparing an air pressure value which was self-determined with an air pressure value which was transmitted.
